(19) United States
(12) Patent Application Publication
(10) Pub. No.: US 2022/0122032 A1
(43) Pub. Date: Apr. 21, 2022

(54) WORK INSTRUCTION DEVICE AND WORK INSTRUCTION SYSTEM

(71) Applicant: TOSHIBA TEC KABUSHIKI KAISHA, Tokyo (JP)

(72) Inventor: Yoshiyuki Hirahara, Mishima Shizuoka (JP)

(21) Appl. No.: 17/461,388

(22) Filed: Aug. 30, 2021

(30) Foreign Application Priority Data
Oct. 20, 2020 (JP) 2020-176009

(51) Int. Cl. G06Q 10/08; G05D 1/02

(52) U.S. Cl. CPC G06Q 10/0833; G05D 2201/0216; G05D 1/0212; G06Q 10/0875

(57) ABSTRACT

A work instruction device includes a first interface to acquire information regarding commodities received and available for shipping to another destination, sorting information indicating a requested number of commodities for each of different commodity types by shipping destination, and carriage information of a carriage onto which commodities are to be placed for shipping. A processor is configured to set, based on the received information, a placement position on the carriage for each of the requested commodity types, placement positions for the requested commodity types being side by side on the carriage, and a stacked number for each of the requested commodity types at the respective placement positions. A second interface transmits a work instruction to a display device that indicates the set placement position on the carriage for each of the requested commodity types and the set stacked number for each of the requested commodity types.

### CROSS-REFERENCE TO RELATED APPLICATION

This application is based upon and claims the benefit of priority from Japanese Patent Application No. 2020-176009, filed Oct. 20, 2020, the entire contents of which are incorporated herein by reference.

### FIELD

Embodiments described herein relate generally to a work instruction device and a work instruction system.

### BACKGROUND

In a distribution system for commodity deliveries, such as food to be sold in stores, the distribution system may include a transfer center (transshipment center) at which commodities from multiple shipping sources are sent before transfer to final destination such as retail store site or the like. At such a transfer center, workers must repetitively carry out work such as reception, inspection, sorting, and delivery of the commodities. For example, the received and then inspected commodities must be sorted by final delivery destinations (shipping destinations). The sorted commodities are typically placed in carriages or containers that are then delivered to the stores.

In the sorting work, the workers place the previously inspected commodities on the carriages or the like which are prepared or set for the individual shipping destinations. In the sorting work at the transfer center, in order to efficiently sort and ship different commodities (different product types) are placed generally placed on the same carriages (which are set according to shipping destinations rather than commodity type), thus many different kinds/types of commodities, which may have different shapes or sizes may have to be placed on the same carriage.

On the other hand, at the stores to which the carriages are being shipped from the transfer center, the various commodities that are delivered have to be counted (inventoried) by kind/type since the stores track product inventory by type rather than just total numbers. Accordingly, the shipping destination stores generally desire commodities of the same type to be arranged together on the delivered carriage even when different commodity types are shipped together.

### BRIEF DESCRIPTION OF THE DRAWINGS

FIG. 1 is a diagram for explaining an example of work instructed by a work instruction system according to an embodiment.

FIG. 2 is a diagram schematically illustrating a configuration example of a work instruction system according to an embodiment.

FIG. 3 is a block diagram illustrating a configuration example of a data server according to an embodiment.

FIG. 4 is a block diagram illustrating a configuration example of an application server functioning as a work instruction device according to an embodiment.

FIG. 5 is a block diagram illustrating a configuration example of a display device according to an embodiment.

FIG. 6 is a flowchart of an operation example of an application server functioning as a work instruction device according to an embodiment.

FIG. 7 is a diagram illustrating an example of a commodity group for a certain shipping destination according to an embodiment.

FIG. 8 is a diagram illustrating an example of commodity placement on a carriage according to an embodiment.

FIG. 9 is a diagram illustrating an example of commodity placement on a carriage according to an embodiment.

FIG. 10 is a diagram illustrating an example of an example of commodity placement on a carriage according to an embodiment.

FIG. 11 is a diagram illustrating an example of commodity placement on a carriage according to an embodiment.

FIG. 12 is a diagram illustrating an example of commodity placement on a carriage according to an embodiment.

FIG. 13 is a diagram illustrating an example of commodity placement according to an embodiment.

FIG. 14 is a flowchart of an operation example of an application server according to an embodiment.

FIG. 15 is a diagram illustrating a display example by a display device according to an embodiment.

FIG. 16 is a diagram illustrating a display example according to an embodiment.

### DETAILED DESCRIPTION

A work instruction device and a work instruction system of at least one embodiment enables workers to more easily perform the work of sorting and arranging a plurality of kinds of commodities on carriages for shipment.

According to one or more embodiments, a work instruction device includes a first interface, a processor, and a second interface. The first interface is configured to acquire received commodity information regarding commodities received and available for shipping to another destination, sorting information indicating a requested number of commodities for each of plurality of requested commodity types by shipping destination, and carriage information for a carriage onto which commodities are to be placed for shipping to the shipping destination. The processor is configured to set, based on the received commodity information, the sorting information, and the carriage information a placement position on the carriage for each of the requested commodity types, placement positions for the requested commodity types being side by side on the carriage, and a stacked number for each of the requested commodity types at the respective placement positions. The second interface is configured to transmit a work instruction to a display device. The work instruction indicates the set placement position on the carriage for each of the requested commodity types and the set stacked number for each of the requested commodity types.

Some example embodiments are described below with reference to the accompanying drawings.

A work instruction system that includes a work instruction device according to one embodiment supports operators for performing work of sorting commodities at a transfer center (or a distribution center or the like). In general, at a transfer center, operators carry out work of loading commodities, which have been received from shipping sources such as producers or manufacturers, onto carriages for each of stores, which are shipping destinations (or delivery destinations or distribution destinations).

A transfer center is a workplace (e.g., a warehouse) for inspecting commodities received from different shipping sources, sorting the inspected commodities into groups by final destination (e.g., store sites), and then shipping the sorted commodities to each final destination (store site). Examples of commodities handled at a transfer center include, but are not limited to, foods including perishable foods, such as fruits and vegetables having best-before dates, use-by dates, expiration dates, or the like. The number of received items, quality of the items, types of items, and packing states often change day to day. And foods, especially perishable foods, may require fast handling/sorting. In view of such difficulties, manual sorting work cannot be replaced or fully automated. The work instruction system of the present disclosure supports the manual sorting work necessary for such commodities as perishable foods, such as vegetables.

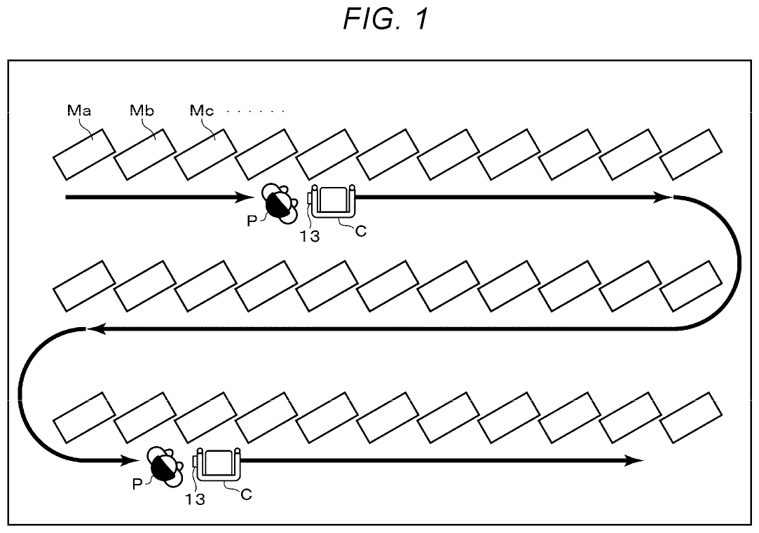

FIG. 1 is a diagram schematically illustrating an example of the sorting work performed by a warehouse worker (operator) at a transfer center using the work instruction system according to the present embodiment. In general, commodities received at the transfer center are inspected prior to being loaded on a “cage carriage,” which is a cart or cart-like on which commodities can be placed. The commodities remain on/in the cage carriage (“carriage” for short) until arrival at the final shipping destination (e.g., store site). Information indicating how many inspected commodities by type have been loaded on each carriage is managed as reception information. The commodities are to be loaded on a particular carriage in amounts corresponding to the amounts ordered by the store to which the particular carriage is destined.

Received commodities are sorted onto a carriage that is set for each shipping destinations. The required number of a commodity on each carriage is set by store ordering information or the like. In sorting work, there can be different schemes utilized. A first scheme is a so-called “picking scheme” and second scheme is a so-called “seeding scheme.” In the picking scheme, an operator moves a carriage (for a particular store or the like) from commodity storage site (disposition place or accumulation place) to commodity storage site and loads the necessary (ordered) number of each commodity type on to the carriage at each storage site in turn. In the seeding scheme, an operator moves a load of one commodity type from carriage to carriage and loads the necessary number of the commodity on each carriage in turn.

FIG. 1 is a diagram for explaining an overview of sorting work by a picking scheme. The example illustrated in FIG. 1 is a diagram illustrating a transfer center where the sorting work by a picking scheme is performed. The operator loads a carriage C with the necessary (ordered) commodities while moving the carriage C along a moving route. When the carriage C arrives at the storage site of a necessary commodity, the operator loads the necessary number of the commodity on to the carriage. The necessary number of each type of commodity can be designated in a work instruction or the like.

A moving route for the carriage C is indicated by arrows in FIG. 1. The operator moves the carriage C along the moving route within the work area of the transfer center. A plurality of disposition places (storage sites) where different commodities M (Ma, Mb, Mc, . . . ) are stored for pick-up by an operator are provided along the moving route.

After initial reception and inspection at the transfer center, the commodities M (Ma, Mb, Mc, . . . ) must be placed in the appropriate disposition places. The appropriate disposition place (accumulation places) for each type of commodities M may be indicated by commodity information or may be indicated by reception information. In the former case, disposition places for commodities are set in advance and received commodities are first sorted to the predetermined disposition places. In the latter case, received and inspected commodities can be disposed in any of the available disposition places at the transfer center and the information indicating at which particular place the commodities have been placed can be indicated by reception information.

An operator P moves the carriage C along the moving route. The carriage C is destined to one specific shipping destination (or a delivery destination). The operator P loads the various commodities M onto the carriage C according to a work instruction displayed on a display device 13 of the carriage C or the like. The display device 13 displays the work instruction indicating how many items of which commodities M (e.g., 5 of commodity Ma, 12 of commodity Mb, zero of commodity Mc) are to be loaded onto the carriage C. The work instruction also designates a particular placement position(s) on the carriage C on which the different commodities M should be loaded/placed.

Based on the reception information regarding each commodity, the sorting information, commodity information, carriage information for each destination store, and the like, the work instruction system 1 determines, the commodity M types to be placed on a carriage C, placement positions for the different commodity M types on the carriage C, and the numbers of items of each commodity M type to be stacked (the numbers of items to be loaded) on the carriage C, and the like regarding the commodities to be shipped to store corresponding to a particular carriage C. The work instruction system 1 generates work instruction information corresponding to the commodities to be shipped to store corresponding to the particular carriage C. Based on the generated work instruction information, the work instruction system 1 causes the display device 13 to display a work instruction (may also be referred to as a work guide) for instructing how many items of which type of commodities M should be loaded and stacked at which positions of the carriage C by the operator P. The operator P moves the carriage C to the disposition places where the commodities M have previously been disposed and loads the designated numbers of items for each commodity type onto the carriage C according to the work instruction displayed on the display device 13.

The display device 13 only has visually observable by the operator P. For example, the display device 13 may be configured to be detachable from the carriage C and thus hand-held or carried by the operator P. The display device may be at a fixed location within the transfer center. The display device 13 may be carried around the neck of the operator P to permit the operator P glance occasionally at the display screen while performing the sorting work.

In the seeding scheme, the operator P, for example, moves a cart (which may be the same structure as a cage carriage but lacking a specified shipping destination) on which received commodities have been placed. The operator then moves the cart past various carriages destined for specific stores (final destinations) or the like. The operator moves the cart carriage to carriage and unloads the necessary (ordered) number of commodities onto each carriage in turn according to shipping destination. When the seeding scheme is adopted, the cart on which the received commodities (unsorted by final destination) are placed, only has to be moved along a moving route past the carriages of the various shipping destinations. In this case, the work instruction system 1 only has to cause the display device 13 to display placement positions and the numbers items (by commodity type) on the various carriages for the shipping destinations.

The work instruction system 1 according to the present disclosure can be applied to different sorting work schemes. However, in the following explanation, the work instruction system 1 is explained assuming the sorting work is performed using a picking scheme.

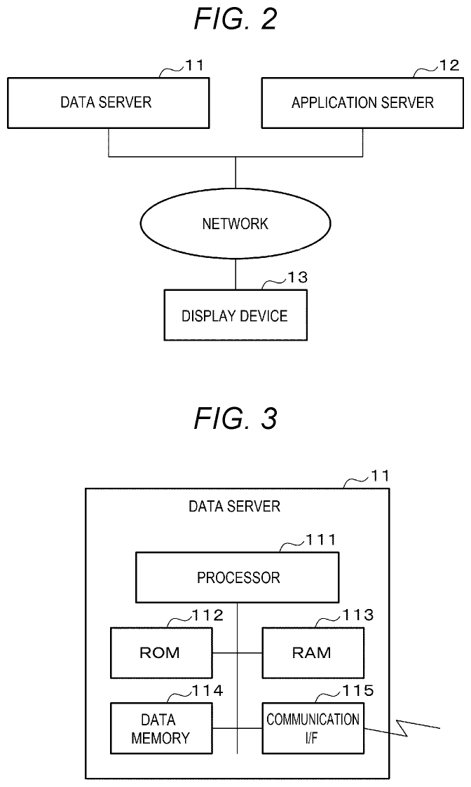

FIG. 2 is a diagram illustrating a configuration example of the work instruction system 1 in the case of the picking scheme sorting work according to the present embodiment. The work instruction system 1 includes a data server 11, an application server 12, the display device 13, and the like. The data server 11, the application server 12, and the display device 13 are communicably connected via a network or the like.

The data server 11 manages various kinds of information concerning reception, sorting, and the like regarding commodities, articles, products, goods, etc. The data server 11 has a function of communicating with another device, such as the application server 12 functioning as a work instruction device. For example, the data server 11 includes various databases that store various kinds of information. The data server 11 provides information in response to a request from the application server 12. The data server 11 collects or acquires information indicating a result of reception and inspection work and a result of sorting work from the application server 12 or the like.

The application server 12 is the work instruction device that instructs or informs the operator of the content of work that the operator should carry out. The application server 12 is realized by a computer or other an information processing device that executes an application program, such as a work instruction application, for generating the work instruction information. The application server 12 specifies the work content based on the information acquired from the data server 11 or the like. The application server 12 generates the work instruction information for instructing the operator corresponding to the work content to perform the work. The application server 12 transmits the work instruction information to the display device 13 that displays the work instruction and other appropriate information.

The display device 13 displays a work instruction screen or the like for informing the operator about the work content. The display device 13 includes an information processing terminal having a display with a touch panel, such as a tablet PC or a smartphone. The display device 13 displays, based on the work instruction information acquired from the application server 12, information that should be notified to the operator, such as the work instruction. The display device 13 is set in a position where the operator can easily view the work instruction screen displayed on the display device 13 while performing other work, such as sorting of commodities. For example, the display device 13 is attached to each carriage on which the commodities (which are the received and inspected commodities) are to be loaded.

The work instruction application may be executed by the data server 11 or by the display device 13. For example, the data server 11 and the application server 12 may be realized as one information processing device (that is the work instruction device), such as a general-purpose server device. In this case, the data server 11 may generate the work instruction information by executing the work instruction application. This can be realized by providing, in the data server 11, an interface that communicates with the display device 13. In this case, in the work instruction system 1, the application server 12 functioning as hardware may be omitted.

The application server 12 and the display device 13 may be realized by one information processing device (that is the work instruction device) including a display, such as a tablet PC or a smartphone. In this case, the display device 13 may generate the work instruction information by executing the work instruction application. This can be realized by providing, in the display device 13, an interface that communicates with the data server 11. In this case, in the work instruction system 1, the application server 12 functioning as hardware may be omitted. In another embodiment, the data server 11, the application server 12, and the display device 13 may be realized by one information processing device (as a work instruction device).

FIG. 3 is a block diagram illustrating a configuration example of the data server 11 of the work instruction system 1 according to the present embodiment. As illustrated in FIG. 3, the data server 11 includes a processor 111, a read-only memory (ROM) 112, a random-access memory (RAM) 113, a data memory 114, and a communication interface (I/F) 115.

The processor 111 performs various kinds of processing by executing a program (or programs). The processor 111 executes a program, such as a system program, an application program, or firmware, stored in the ROM 112, the data memory 114, or the like. The processor 111 is, for example, a central processing unit (CPU), a microprocessing unit (MPU), or a digital signal processor (DSP). The processor 111 may be a combination of a plurality of CPUs, MPUs, DSPs, or the like.

The ROM 112 is a nonvolatile memory used to read out data. The ROM 112 stores a program to be executed by the processor 111. The ROM 112 stores data, various setting values, or the like used by the processor 111 to perform various kinds of processing. The RAM 113 is a memory used to read and write data. The RAM 113 is used as, for example, a working memory that stores data temporarily used by the processor 111 in performing various kinds of processing.

The data memory 114 is a rewritable nonvolatile memory. The data memory 114 stores various data that are managed by the work instruction system 1. The data memory 114 may store a program (or programs) to be executed by the processor 111 and/or setting values. For example, the data memory 114 stores information indicating reception information of commodities, sorting information (e.g., the number of items by commodity type for each of shipping destination), and the like.

The data memory 114 also stores commodity information concerning the commodities to be handled, carriage information concerning carriages to be used for sorting work, and the like. For example, the commodity information for the respective commodities (commodity types) includes information such as commodity identification or commodity codes, commodity names, expected weights for each sorting unit, and sizes (such as lengths, widths, and heights) for each sorting unit. The commodity information may include information for determining an order for placing the commodities of different types on a carriage. For example, information indicating the disposition places of the different commodities can be stored as part of the commodity information. The information indicating the disposition places of the commodities may also or instead be stored as part of the reception information for the received commodities.

In this context, a “sorting unit” refers to a predetermined amount, such as a predetermined number or a predetermined weight, in which a commodity is to be shipped. For example, a sorting unit may be a packing box in which a predetermined amount of a particular commodity type is to be put for purposes of shipping. For example, a sorting unit for apples may be a specifically sized box (e.g., fixed volume) in which a specific weight of apples (within acceptable tolerance) are to be packed. In the example explained below, it is assumed that the commodities have been counted in to sorting units and the weight of the commodities is the overall weight of the sorting unit.

The carriage information relates to the carriages to be used for delivering commodities to stores, that are the carriages for the respective destination stores. The carriage information includes information indicating the size of a commodity loadable region (such as the size including length, width, and height of a space in which commodities can be loaded) of each carriage for each corresponding store. If a plurality of types of carriages are present, the carriage information include information indicating the size of a commodity loadable region of each carriage type. The information saved in the data memory 114 may be stored in another device (for example, another server) accessible by the processor 111.

The communication interface 115 is for performing communication, such as wireless communication or wired communication, via a network. For example, the communication interface 115 includes an interface for communicating with the application server 12 or the display device 13 via a secure local network. The communication interface 115 may include an interface for communicating with the application server 12 and an interface for communicating with the display device 13. The processor 111 communicates with the application server 12 or the display device 13 via the communication interface 115.

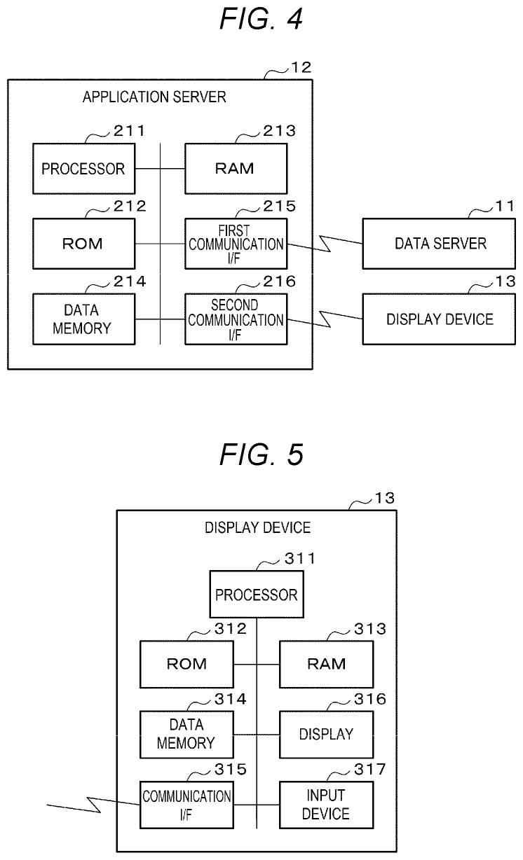

FIG. 4 is a block diagram illustrating a configuration example of the application server 12 of the work instruction system 1 according to the present embodiment. As illustrated in FIG. 4, the application server 12 includes a processor 211, a ROM 212, a RAM 213, a data memory 214, a first communication interface (I/F) 215, and a second communication interface (I/F) 216.

The processor (a first processor) 211 executes a program to perform various kinds of processing. The processor 211 executes a program, such as a system program, an application program, or firmware, stored in the ROM 212, the data memory 214, or the like. The processor 211 is, for example, a CPU, an MPU, or a DSP. The processor 211 may be a combination of a plurality of CPUs, MPUs, DSPs, or the like.

The ROM 212 is a nonvolatile memory used to read out data. The ROM 212 stores a program to be executed by the processor 211. The ROM 212 stores data, various setting values, or the like used by the processor 211 to perform various kinds of processing. The RAM 213 is a memory used to read and write data. The RAM 213 is used as, for example, a working memory that stores data temporarily used by the processor 211 in performing various kinds of processing.

The data memory 214 is a rewritable nonvolatile memory that saves various data. The data memory 214 stores collected various data. The data memory 214 may store a program to be executed by the processor 211 and/or setting values. The data memory 214 may store data and the like generated in processing by the processor 211. For example, the work instruction information generated in the processing according to the present embodiment is stored in the data memory 214.

The first communication interface (may also be referred to as a first interface) 215 is for communicating with the data server 11. The processor 211 communicates with the data server 11 via the first communication interface 215. The second communication interface (may also be referred to as a second interface) 216 is for communicating with the display device 13. The processor 211 communicates with the display device 13 via the second communication interface 216. The first and second communication interfaces 215 and 216 may use wired communication or wireless communication.

For example, the first communication interface 215 includes an interface for communicating with the data server 11 via a secure local network. The second communication interface 216 includes an interface conforming to a communication scheme or protocol of the display device 13. For example, the second communication interface 216 includes an interface for a wireless LAN or wireless communication, such as short-range wireless communication, to wirelessly communicate with the display device 13.

FIG. 5 is a block diagram illustrating a configuration example of the display device 13 in the work instruction system 1 according to the present embodiment. As illustrated in FIG. 5, the display device 13 includes a processor 311, a ROM 312, a RAM 313, a data memory 314, a communication interface (I/F) 315, a display 316, and an input device 317.

The processor (a second processor) 311 executes a program to perform various kinds of processing. The processor 311 executes a program, such as a system program, an application program, or firmware, stored in the ROM 312, the data memory 314, or the like. The processor 311 is, for example, a CPU, an MPU, or a DSP. The processor 311 may be a combination of a plurality of CPUs, MPUs, DSPs, and the like.

The ROM 312 is a nonvolatile memory used to read out data. The ROM 312 stores a program to be executed by the processor 311. The ROM 312 stores data, various setting values, or the like used by the processor 311 to perform predetermined various kinds of processing. The RAM 313 is a memory used to read and write data. The RAM 313 is used as, for example, a working memory that stores data temporarily used by the processor 311 in performing various kinds of processing.

The data memory 314 is a rewritable nonvolatile memory that saves various data. For example, the data memory 314 stores an application program for prediction processing executed by the processor 311. The data memory 314 may store a program to be executed by the processor 311 and/or setting values. The data memory 314 may store data and the like generated in the processing by the processor 311.

The communication interface 315 (a third interface) is for communicating with the data server 11 and the application server 12 via a network. For example, the communication interface 315 includes an interface that communicates with the data server 11 and the application server 12 through a wireless LAN or wireless communication such as short-range wireless communication. The communication interface 315 may include an interface for communicating with the data server 11 or the application server 12 via a secure local network.

The display 316 is a display device that displays information. For example, the display 316 displays information presented to an operator. The input device 317 is a device that receives an instruction input from the operator. The input device 317 notifies the processor 311 of the content of the instruction input by the operator. For example, the input device 317 includes a touch panel, ten keys, a keyboard, a mouse, or the like. The display 316 and the input device 317 include a display with a touch panel.

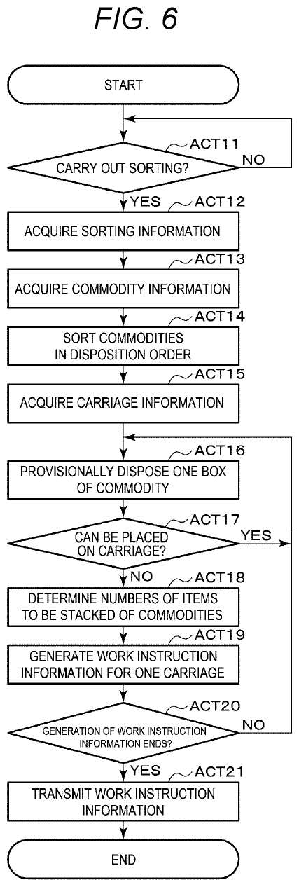

FIG. 6 is a flowchart of an operation example of the application server 12 according to the present embodiment. Every time reception and inspection of commodities are completed at a transfer center, the data server 11 stores, in the data memory 114, reception information indicating, for example, the number of the received and inspected commodities, (which are the commodities that can be shipped to destinations from the transfer center). In one instance, the data server 11 acquires the reception information indicating the reception and inspection results from an external device capable of communicating with the data server 11 via a communication interface. Such an external device may be, for example, a management system that manages the reception and inspection work. The reception information includes the number of the received and inspected commodities. The reception information may include information indicating how many commodities after the reception and inspection work are to be placed on carriages (cart trucks, cage carriages, or the like).

Every time the data server 11 acquires the reception information, the data server 11 generates sorting information for sorting the received and inspected commodities to shipping destinations, such as destination stores. The data memory 114 of the data server 11 stores the sorting information of the commodities. The sorting information are used for allocating the received and inspected commodities to the shipping destinations. The sorting information includes information indicating the number of commodities sorted to the shipping destinations, that is the number of commodities to be shipped.

When the available number of a received and inspected commodity satisfies the total ordered by the various stores, then each order for the commodity for the stores (shipping destinations) can be totally fulfilled and the number of the commodity to be loaded and shipped simply matches the ordered number for each store. However, if the available number of the received and inspected commodity does not satisfy the total number ordered by the various stores, then number of the commodity to be loaded and shipped to each store may have to be determined by some sort of decision-making or rationing algorithm. The processing for generating the sorting information may be executed by a separately provided computer. The data server 11 may acquire the sorting information as the processing result.

The data memory 114 of the data server 11 stores commodity information, carriage information, and the like as well. The commodity information relates to the commodities that are being sorted (the sorting targets). The commodity information includes information indicating the size of each commodity and/or the size of a sorting unit of each commodity. For example, a size of a box used as sorting unit for a commodity can be included. For example, if the box (or other packaging) is a rectangular parallelepiped, information indicating length, width, and height of the box. If a particular direction/orientation for the box for the commodity is required, the size can be indicated by longitudinal (long side) length of a bottom surface, lateral (short side) length of the bottom surface, and height reflecting the state in which the commodity (sorting unit) is to be placed on the carriage. The commodity information can also include information indicating a disposition position for the commodity (or a disposition order for the commodity with respect to a predetermined moving route).

The carriage information includes information indicating a size of the loadable region where a commodity can be loaded in a carriage used for shipping the commodity to a destination store. As the size of the loadable region, for example, information indicating a size of a surface (may also be referred to as a placement surface) of the carriage on which the commodity is to be placed is included in the carriage information. For example, if the placement surface is rectangular, the size thereof is indicated by longitudinal (long side) length and lateral (short side) length of the rectangular surface. Further, as the size of the loadable region, information indicating height to which the commodity can be stacked is included in the carriage information. For example, if a plurality of commodities are to be stacked and placed within the loadable region of the placement surface of the carriage, the plurality of commodities will be stacked to be equal to or lower than the height of the loadable region as identified in the carriage information.

As shown in the flowchart of FIG. 6, first, the processor 211 of the application server 12 receives an instruction to start sorting work for placing the received and inspected commodity (which are the ones disposed at the disposition places for sorting) on carriages assigned for the respective destination stores (ACT 11). For example, the instruction to start the sorting work is input by the input device 317 of the display device 13, and the application server 12 receives the start instruction from the display device 13 via the second communication interface 216. Upon receipt of the start instruction (YES in ACT 11), the processor 211 starts generating work instruction information for the sorting work. For example, the processor 211 may start generating the sorting-work instruction information if a notification indicating that the reception and inspection of the predetermined plurality of commodities are complete is received from the data server 11 via the first communication interface 215. Alternatively, the processor 211 may start generating the sorting-work instruction information at a predetermined time.

To generate the sorting-work instruction information, the processor 211 first acquires the sorting information for each of the destination stores of each of the commodities from the data server 11 via the first communication interface 215 (ACT 12). The processor 211 determines, based on the acquired sorting information, a kind or a type, quantity, and the like of each commodity that is to be shipped to each corresponding store.

After the acquisition of the sorting information, the processor 211 acquires from the data server 11, via the first communication interface 215, the commodity information of the commodities which are the sorting targets, included in the sorting information for each of the stores (ACT 13). The commodity information includes information concerning the size of each commodity. The processor 211 retains the acquired commodity information (including the commodity size information) in the RAM 213 or the data memory 214.

After the acquisition of the commodity information, the processor 211 sorts the sorting-target commodities in order of disposition (ACT 14). The commodity information acquired from the data server 11 includes information related to the disposition positions of the commodities. The processor 211 specifies determines the disposition positions of the commodities based on the acquired commodity information. In the present embodiment, the sorting-target commodities are placed on the carriage in order conforming to the moving route. Accordingly, the processor 211 sorts, based on the disposition positions, the sorting-target commodities such that they are placed on the carriage in order conforming to the moving route.

The processor 211 then acquires from the data server 11, via the first communication interface 215, the carriage information concerning the carriage on which the sorting-target commodity is to be placed (ACT 15). The carriage information indicates, as the size of a loadable region, the size of a placement surface on which the commodity is to be placed and height to which the commodity can be loaded or stacked.

After the acquisition of the carriage information, the processor 211 generates work instruction information indicating the position and the number of items of each of the commodities to be placed on the carriage. For example, the processor 211 runs a simulation of provisionally placing one commodity, that is one commodity box being the soring unit, on the placement surface of the carriage in order of sorting (ACT 16). If the simulation indicates that the commodity can be placed on the placement surface of the carriage (YES in ACT 17), the processor 211 repeats the simulation of the provisional placement of other commodities in order of sorting. The processor 211 may simulate a placement state of the commodity based on the size of the placement surface of the carriage and the size of the bottom surface of the commodity.

If the simulation indicates that no further commodities cannot be placed on the carriage, that is the loadable region of the carriage has become full with the commodities (NO in ACT 17), the processor 211 determines the simulated placement positions of the commodities on the placement surface within the loadable region of the carriage. The processor 211 also determines the number of items (or the number of items to be loaded) of the commodity of the same kind (or type or the like) that can be stacked at each of the simulated placement positions on the placement surface of the carriage according to the simulation (ACT 18).

The number items of the same commodity type (sorting units) to be stacked one on the other is set based on the necessary (ordered) number of the commodity, the height of the commodity (sorting unit), and the maximum height to which any commodity (or a particular commodity type) can be loaded in the carriage. The processor 211 determines, based on the height of the commodity and the maximum height to which the commodity can be loaded, whether the necessary number of commodities can be stacked. If all the ordered number can be stacked without exceeding the maximum stacking height, the processor 211 sets the number of items to be stacked to the ordered number. If the ordered number of the commodity cannot be loaded without exceeding the maximum height limit, the processor 211 sets the number of items to be stacked, the maximum number that can be stacked without exceeding the maximum stacking height (the maximum number that can be stacked can be calculated from the height of the commodity and the height to which the commodity can be loaded on the carriage).

Once the placement positions for the commodities and the numbers of items to be stacked are set, the processor 211 generates the work instruction information for the carriage. The work instruction information indicates the placement positions for the commodities and the numbers of items to be stacked on that carriage (ACT 19). The work instruction information also includes information concerning the sorting work, such as order of the sorting work and a commodity name and shipping destination of each sorting-target commodity.

After generating the work instruction information for one carriage, the processor 211 determines whether to end the generation of the work instruction information (ACT 20). For example, if there still remain other sorting-target commodities, the processor 211 determines to generate work instruction information for the next carriage for the remaining sorting-target commodities (NO in ACT 20) and returns to ACT 16 to repeat the processing until all necessary work instruction information are generated.

If the generation of the work instruction information is complete (YES in ACT 20), the processor 211 transmits the generated work instruction information to the display device 13 via the second communication interface 216 (ACT 21).

According to the processing of the present embodiment, the application server 12 functioning as the work instruction device determines the placement positions of the commodities by the simulation of provisionally placing the commodities on the carriage in order of sorting. Further, the application server 12 determines the number of items of the commodities of the same kind to be stacked at each of the determined placement positions on the carriage. The application server 12 generates the work instruction information indicating the determined placement position and number of items for each of the commodities and supplies the generated work instruction information to the display device 13. Consequently, the display device 13 can execute guidance of the work instruction based on the work instruction information received from the application server 12.

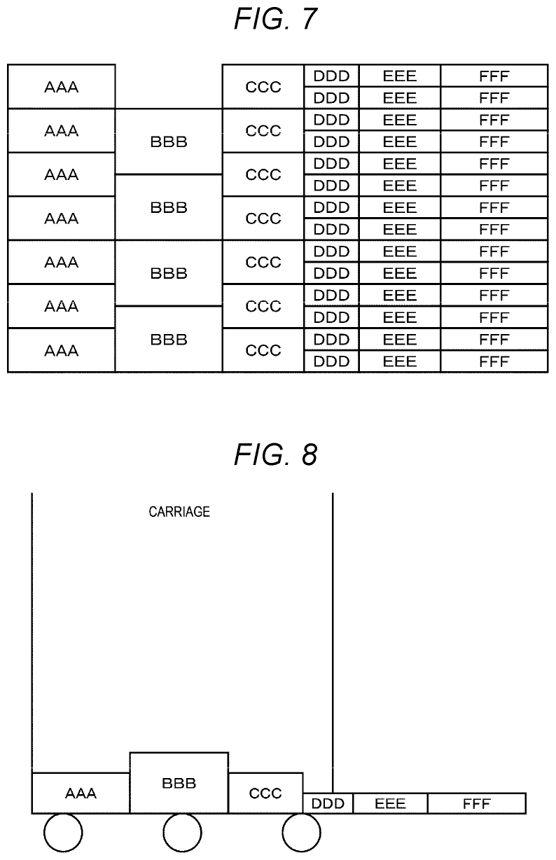

FIG. 7 is a diagram schematically illustrating an example of a commodity group as a sorting target to be shipped to one destination store. In the example illustrated in FIG. 7, there are a plurality of kinds (“AAA”, “BBB”, “CCC”, “DDD”, “EEE”, and “FFF”) of commodity, and each kind has a plurality of items or boxes. Order of commodity disposition is the same as order of “AAA”, “BBB”, “CCC”, “DDD”, “EEE”, and “FFF” in this example.

FIG. 8 is a diagram illustrating an example simulation by the application server (work instruction device) 12, in which one box of each kind of commodity illustrated in FIG. 7 is provisionally placed on the carriage in order of disposition. In the example illustrated in FIG. 8, the commodities “AAA”, “BBB”, and “CCC” can be placed on the placement surface of the carriage, but the other commodities “DDD”, “EEE”, and “FFF exceed the placement surface of the carriage. Based on the simulation result, the processor 211 determines that a sum of the sizes (or a total size) of the three commodities “AAA”, “BBB”, and “CCC” is equal to or smaller than the loadable size of the carriage and that a sum of the sizes (or a total size) of the four commodities “AAA”, “BBB”, “CCC”, and “DDD” is greater than the loadable size of the carriage. Consequently, the processor 211 determines that the three commodities “AAA”, “BBB”, and “CCC” can be placed on the carriage.

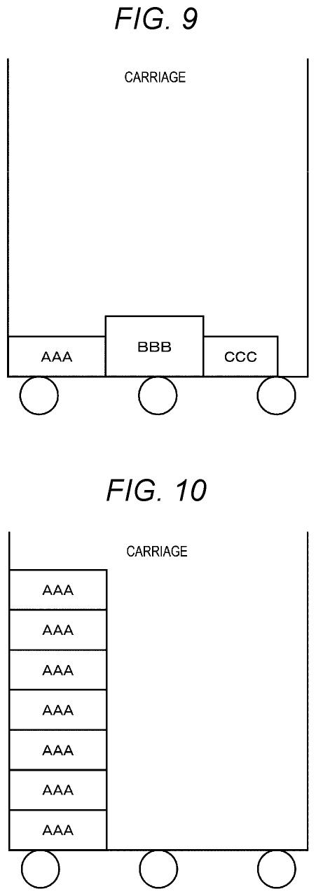

FIG. 9 is a diagram illustrating the placement positions of the three commodities “AAA”, “BBB”, and “CCC”, except for the fourth and subsequent commodities “DDD”, “EEE”, and “FFF” that cannot be placed on the carriage, among the commodities provisionally placed as illustrated in FIG. 8. Based on the simulation result, the processor 211 determines that actual placement positions of the three commodities “AAA”, “BBB”, and “CCC” on an actual carriage operated by an operator at a transfer center are to be the same as the simulated placement positions as illustrated in FIG. 9.

Once the placement positions on the carriage have been determined and designated for the three commodities, the processor 211 determines, based on the sorting information for the destination store, the number of items of each of the three commodities to be stacked at each placement position (that is how many boxes of each commodity can be stacked at the corresponding placement position) on the carriage as illustrated in FIG. 9. For example, the processor 211 determines such number based both on the height (or the box height) and the requested (ordered) number for each of the three commodities “AAA”, “BBB”, and “CCC” and on the height of the loadable region of the carriage. If the total height obtained by multiplying the height of one commodity (or one box) with the requested number of that commodity is equal to or smaller than the height of the loadable region of the carriage, the processor 211 determines that the number of items to be stacked is equal to the requested number of that commodity. If the total height exceeds the height of the loadable region of the carriage, the processor 211 sets the maximum number of the commodity that can be stacked without exceeding the maximum height of the loadable region of the carriage to be the number of items to be stacked.

FIG. 10 is a diagram illustrating a state in which seven sorting units (seven boxes) of the commodity “AAA” are stacked at the designated placement position on the carriage. In the example illustrated in FIG. 7, the ordered number of the commodity “AAA” is seven. Since the total Neigh obtained by multiplying the height of the commodity “AAA” (more particularly its sorting unit size) by seven is equal to or less than the height of the loadable region of the carriage, the processor 211 sets the number of items (or boxes) of the commodity “AAA” to be stacked on the designated placement position to seven as illustrated in FIG. 10.

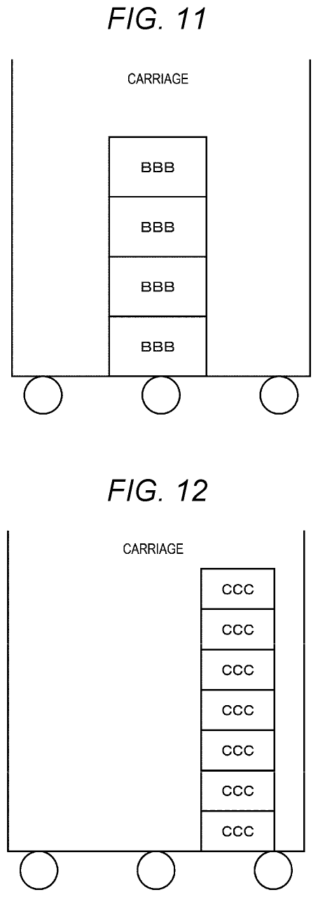

FIG. 11 is a diagram illustrating a state in which four sorting units (four boxes) of the commodity “BBB” are stacked at the designated placement position on the carriage. In the example illustrated in FIG. 7, the ordered number of the commodity “BBB” is four. Since the total height obtained by multiplying the height of the commodity “BBB” by four is equal to or less than the height of the loadable region of the carriage, the processor 211 set the number of items (or boxes) of the commodity “BBB” to be stacked at the designated placement position to four as illustrated in FIG. 11.

FIG. 12 is a diagram illustrating a state in which seven sorting units (seven boxes) of the commodity “CCC” are stacked at the designated placement position on the carriage. In the example illustrated in FIG. 7, the ordered number of the commodity “CCC” is seven. Since the total height obtained by multiplying the height of the commodity “CCC” by seven is equal to or less than the height of the loadable region of the carriage, the processor 211 sets the number of items (or boxes) of the commodity “CCC” to be stacked at the designated placement position to seven as illustrated in FIG. 12.

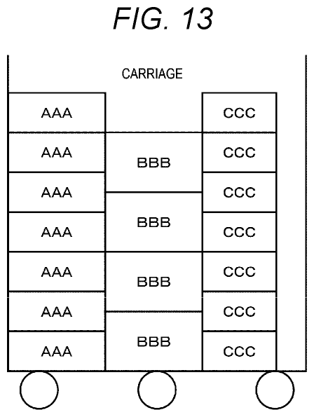

FIG. 13 is a diagram illustrating a state in which the three commodities “AAA”, “BBB”, and “CCC” are stacked as determined based on the simulation run by the application server (work instruction device) 12. By combining the stacked states of the three commodities illustrated in FIGS. 10, 11, and 12, the stacking result of the three commodities on one carriage can be obtained as illustrated in FIG. 13.

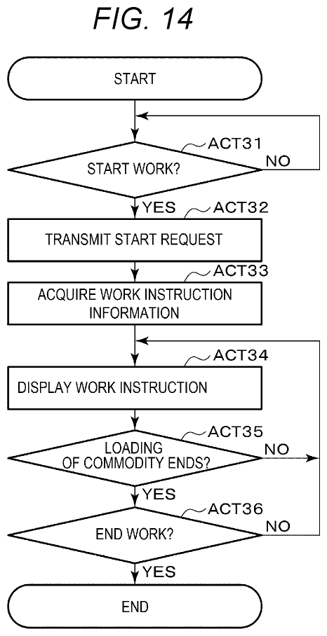

FIG. 14 is a flowchart of an operation example of the display device 13 in the work instruction system 1 according to the present embodiment. The processor 311 of the display device 13 determines whether a start instruction for sorting work is input by an operator (ACT 31). For example, the processor 311 receives a start instruction for sorting work when the operator operates the input device 317 to enter the start instruction. Upon receipt of the sorting-work start instruction, the processor 311 may request input of identification information of the operator.

Once the sorting-work start instruction is detected (YES in ACT 31), the processor 311 transmits a start request for the sorting work to the application server (the work instruction device) 12 via the communication interface 315 (ACT 32). After transmitting the start request for the sorting work, the processor 311 acquires work instruction information from the application server 12 (ACT 33).

Once the work instruction information is acquired, the processor 311 displays a guidance screen for the sorting work on the display 316 according to the sorting-work start instruction input by the input device 317 (ACT 34). For example, the processor 311 displays, on the display 316, a work instruction screen for guiding the sorting work of placing a commodity on a carriage for a store designated by an operator.

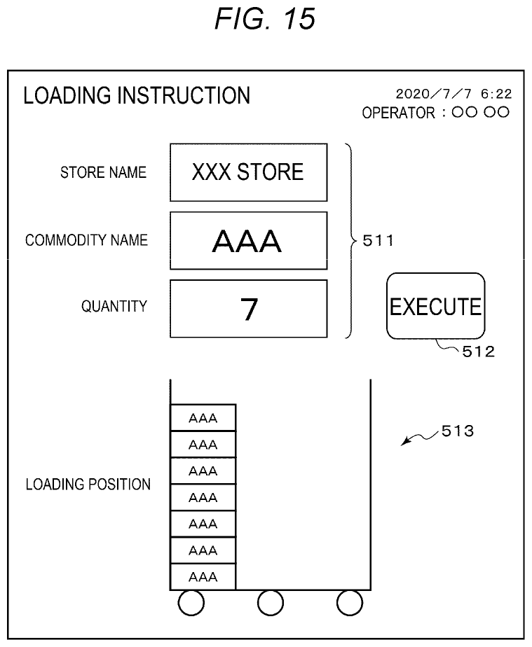

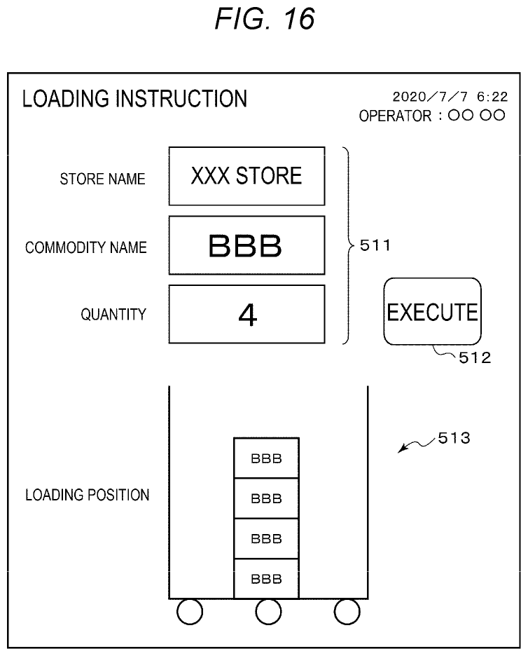

FIGS. 15 and 16 are diagrams illustrating display examples of the work instruction screen displayed on the display 316 by the display device 13. The work instruction screen illustrated in FIGS. 15 and 16 displays the guidance including the work instruction for sorting. The work instruction screen is a guidance screen that the operator visually recognizes while performing work for loading a designated commodity onto a carriage for a destination store. In the display examples illustrated in FIGS. 15 and 16, the display device 13 displays, on the display 316, the work instruction screen including a display field 511, an execution button 512, and a placement position image 513.

The display field 511 displays the sorting information including the name of the shipping-destination store, the name of the sorting-target commodity, and the quantity of, that is the number of items (boxes) of the sorting-target commodity to be stacked at the designated placement position on the carriage.

The placement position image 513 is for informing the operator of the placement position where the commodity is to be placed on the carriage for the destination store, a stacking state of the commodity, and the like. The example of the placement position image 513 illustrated in FIG. 15 shows the state in which the designated number of boxes (seven) of the target commodity (“AAA”) as identified in the display field 511 are stacked on the carriage. With the placement position image 513, the operator can intuitively, visually recognize where in the carriage the commodity should be placed and stacked.

In the present embodiment, so long as the placement position image 513 can inform the operator of the position where the commodity is to be placed on the carriage, such images are not limited in any way. For example, while the placement position image 513 illustrated in FIG. 15 shows the state in which only the commodity “AAA” is stacked on the carriage, any commodities that have already been placed on the carriage may also be displayed in the placement position image 513 in addition to the to-be-stacked commodity “AAA” on the carriage.

The execution button 512 is operated when the operator completes the loading of the commodity of the quantity displayed in the display field 511 on the carriage. If the execution button 512 is operated and if there are still other commodities that should be placed on the carriage, the display contents of both the display field 511 and the placement position image 513 will be updated.

For example, the name and quantity of the next commodity that should be placed on the same carriage as the previous commodity is displayed in the display field 511, and an image indicating the position where the next commodity is to be placed is displayed as the placement position image 513. For example, in the case where the sorting work of placing the commodity “BBB” on the carriage for “XXX store” next to the commodity “AAA” is instructed, the display device 13 causes the display 316 to update the guidance screen as illustrated in FIG. 16 when the execution button 512 is pressed or touched by the operator.

Referring back to FIG. 14, every time the loading of the individual commodity ends, the processor 311 determines whether the entire loading work for all the commodities ends (ACT 35). For example, the processor 311 determines, according to whether the execution button 512 is operated, whether the loading work for the displayed commodity ends. If the loading work for the displayed commodity does not end (NO in ACT 35), the processor 311 causes the display 316 to continuously display the work instruction screen.

If the loading work for the displayed commodity ends (YES in ACT 35), the processor 311 further determines whether the entire sorting work ends (ACT 36). For example, the processor 311 determines whether other commodities that should be placed on the carriage next are present and whether to end the entire sorting work. If other target commodities still exist, the processor 311 determines to continue the sorting work (NO in ACT 36) and returns to ACT 34 and causes the display 316 to update the work instruction screen for the next commodity to be placed on the carriage.

If there are no further commodities that should be placed on the carriage next, the processor 311 determines to end the sorting work (YES in ACT 36) and ends the series of processing. When ending the sorting work, the processor 311 may cause the display 316 to display that the sorting work is complete. The processor 311 may notify the application server 12 of information indicating the result of carrying out the completed sorting work.

According to the processing of the present embodiment, the display device 13 acquires, from the application server 12, the work instruction information including the information indicating the placement position and the number of items (boxes, for example) to be stacked of each of the commodities. The display device 13 then displays, based on the acquired work instruction information, the work instruction screen including the image showing the placement position and the number of items to be stacked of each of the commodities. Consequently, an operator can visually recognize such information as a guidance displayed by the display device 13 while carrying out the sorting work and can easily perform the work for stacking the commodities on the carriage according to the work instruction.

In the present embodiment, the program to be executed by the processor, such as the processors 111, 211, and 311, is stored in advance in the appropriate memory in the device of the work instruction system 1, such as the data sever 11, the application server 12, and the display device 13. The program may be downloaded from a network to the device or may be installed in the device from a storage medium. The storage medium may be a storage medium that can store the program and can be read by the device. A function obtained by installation or download of the program in advance may be realized in cooperation with an operating system (OS) in the device.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A work instruction device, comprising:
a first interface configured to acquire received commodity information regarding commodities received and available for shipping to another destination, sorting information indicating a requested number of commodities for each of a plurality of requested commodity types by shipping destination, and carriage information for a carriage onto which commodities are to be placed for shipping to a shipping destination;
a processor configured to set, based on the received commodity information, the sorting information, and the carriage information:
a placement position on the carriage for each of the requested commodity types, placement positions for the requested commodity types being side by side to one another on the carriage, and
a stacked number for each of the requested commodity types at the respective placement positions; and
a second interface configured to transmit a work instruction to a display device, the work instruction indicating the set placement position on the carriage for each of the requested commodity types and the set stacked number for each of the requested commodity types.

2. The work instruction device according to claim 1, wherein
the received commodity information includes a size for each of the requested commodity types, and
the placement positions of each of the requested commodity types are set based on the size of each of the requested commodity types.

3. The work instruction device according to claim 2, wherein
the size includes a planar dimension of a bottom surface of a shipping unit of the respective requested commodity types, and
an available size of a placement surface on the carriage is specified in the carriage information.

4. The work instruction device according to claim 3, wherein the processor is further configured to determine whether a sum of the sizes of the bottom surfaces of the requested commodity types exceeds the available size of the placement surface on the carriage.

5. The work instruction device according to claim 3, wherein
the carriage information further includes a maximum height for stacked commodities on the placement surface of the carriage, and
the processor is further configured to set the stacked number for each of the requested commodity types based on the maximum height for stacked commodities in the carriage information and a stacking height dimension for each of the requested commodity types included in the commodity information.

6. The work instruction device according to claim 5, wherein the processor is further configured to determine whether the requested number of any of the requested commodity types will exceed the maximum height if stacked on the placement surface in a single stack.

7. The work instruction device according to claim 1, wherein
the received commodity information further indicates a storage location for each of the requested commodity types within a warehouse, and
the processor is further configured to set placement positions for the requested commodity types on the carriage based on the storage locations for each of the requested commodities along a picking route within the warehouse.

8. The working instruction device according to claim 1, wherein the first interface acquires the received commodity information, the sorting information, and carriage information from a data server.

9. The work instruction device according to claim 1, wherein the commodity types include different types of fresh produce.

10. A work instruction system, comprising:
a work instruction device; and
a display device, wherein
the work instruction device comprises:
a first interface configured to acquire received commodity information regarding commodities received and available for shipping to another destination, sorting information indicating a requested number of commodities for each of a plurality of requested commodity types by shipping destination, and carriage information for a carriage onto which commodities are to be placed for shipping to a shipping destination;
a first processor configured to set, based on the received commodity information, the sorting information, and the carriage information:
a placement position on the carriage for each of the requested commodity types, placement positions for the requested commodity types being side by side on the carriage, and
a stacked number for each of the requested commodity types at the respective placement positions; and
a second interface configured to transmit a work instruction to a display device, the work instruction indicating the set placement position on the carriage for each of the requested commodity types and the set stacked number for each of the requested commodity types; and
the display device comprises:
a display screen;
a third interface configured to receive the work instruction information from the work instruction device; and
a second processor configured to cause the display screen to display the work instruction information.

11. The work instruction system according to claim 10, wherein
the received commodity information includes a size for each of the requested commodity types, and
the placement positions of each of the requested commodity types are set based on the size of each of the requested commodity types.

12. The work instruction system according to claim 11, wherein
the size includes a planar dimension of a bottom surface of a shipping unit of the respective requested commodity types, and
an available size of a placement surface on the carriage is specified in the carriage information.

13. The work instruction system according to claim 12, wherein the first processor is further configured to determine whether a sum of the sizes of the bottom surfaces of the requested commodity types exceeds the available size of the placement surface on the carriage.

14. The work instruction system according to claim 12, wherein
the carriage information further includes a maximum height for stacked commodities on the placement surface of the carriage, and
the first processor is further configured to set the stacked number for each of the requested commodity types based on the maximum height for stacked commodities in the carriage information and a stacking height dimension for each of the requested commodity types included in the commodity information.

15. The work instruction system according to claim 14, wherein the first processor is further configured to determine whether the requested number of any of the requested commodity types will exceed the maximum height if stacked on the placement surface in a single stack.

16. The work instruction system according to claim 10, wherein
the received commodity information further indicates a storage location for each of the requested commodity types within a warehouse, and
the first processor is further configured to set placement positions for the requested commodity types on the carriage based on the storage locations for each of the requested commodities along a picking route within the warehouse.

17. The work instruction system according to claim 10, wherein the first interface acquires the received commodity information, the sorting information, and carriage information from a data server.

18. A non-transitory computer-readable medium storing a program which, when executed, causes a computer to perform a work instruction generation process comprising:
acquiring received commodity information regarding commodities received and available for shipping to another destination, sorting information indicating a requested number of commodities for each of a plurality of requested commodity types by shipping destination, and carriage information for a carriage onto which commodities are to be placed for shipping to a shipping destination;
setting, based on the received commodity information, the sorting information, and the carriage information:
a placement position on the carriage for each of the requested commodity types, placement positions for the requested commodity types being side by side on the carriage, and
a stacked number for each of the requested commodity types at the respective placement positions; and
transmitting a work instruction to a display device, the work instruction indicating the set placement position on the carriage for each of the requested commodity types and the set stacked number for each of the requested commodity types.

19. The non-transitory computer-readable medium according to claim 18, wherein
the received commodity information includes a size for each of the requested commodity types, and
the placement positions of each of the requested commodity types are set based on the size of each of the requested commodity types.

20. The non-transitory computer-readable medium according to claim 18, further comprising:
checking whether a sum of planar dimensions of bottom surfaces of the requested commodity types exceeds an available size of a placement surface on the carriage.
